(19) United States
(12) Patent Application Publication
(10) Pub. No.: US 2024/0165438 A1
(43) Pub. Date: May 23, 2024

(54) BACKWARD ANTI-SLIP ADVENTURE PARK ROLLER

(71) Applicant: Emrah ÖS, ANTALYA (TR)

(72) Inventor: Emrah ÖS, ANTALYA (TR)

(21) Appl. No.: 18/550,910

(22) PCT Filed: Jun. 6, 2022
(86) PCT No.: PCT/TR2022/050537

§ 371 Date: Sep. 15, 2023

(30) Foreign Application Priority Data
Aug. 6, 2021 (TR) 2021/012461

(51) Int. Cl. A62B 35/00; A63G 21/22

(52) U.S. Cl. CPC A62B 35/0081; A63G 21/22

(57) ABSTRACT

A safety roller with backward anti-slip inner cover mechanism that is used in adventure parks, allows the roller to pass without removing the same from the safety rope in station transition areas (such as places where materials such as trees, poles, stations, steel ropes or ropes are tied or fixed, etc.) and in the sloping areas.

### FIELD OF THE INVENTION

The present invention relates to a safety roller with backward anti-slip inner cover mechanism that is used in adventure parks, allows the roller to pass without removing the same from the safety rope in station transition areas (such as places where materials such as trees, poles, stations, steel ropes or ropes are tied or fixed, etc.) and in the sloping areas.

### STATE OF THE ART

In the American document numbered US20170088150A1, a system having a body section and an intermediate plate having a brake carriage for a permanent safety system including a stopper connected to the body section and configured to rest on the pulley, a slidable support tube configured to be mounted around a drive cable, body portion including a connecting flange attached to a first end of the slidable support tube and configured to engage the pull member and attaching to the second end of the slidable support tube and connecting the stopper to the slidable support tube, connecting flange and spacer portion extending in transverse directions with respect to the axial direction and thickness of the slidable support tube is disclosed.

In the Swiss document numbered CH704409B1, the roller for a safety line system comprising a cable support device and a safety cable supported by the cable support device includes a body containing a channel for the passage of the cable, the tensioning device has a rolling device consisting of wheels, a slot less than the diameter of the cable connected to the duct to allow an extension of the cable support device to pass through, and a coupling to allow the attachment of a user's safety rope. The roller further includes a locking mechanism comprising a locking body forming one side of the housing, a shaft connected to the housing, and a locking device configured to lock the locking body. In the locked position, the lock body includes a pivot portion that is configured to pivotally fix the lock body to the roller body so that the lock body can swing from the lock position to an open position where the cable can exit the channel.

In the documents that we have mentioned in the state of the art and that we have not considered as similar documents here, they have the characteristic known as automatic or continuous transition system in security roller station transitions. However, they do not have a roller pulley through which the system can pass due to their design. In addition, since there is no anti-slip system, users can slip uncontrollably from a high point to a low point in sloping areas and cause accidents. Current safety rollers can give security vulnerability as they do not have anti-slip safety systems in sloping areas.

### DESCRIPTION OF THE INVENTION

The present invention has been developed to solve the abovementioned problems in systems included in the state of the art.

While climbing to a higher altitude than the current height where safety rope and equipment should be used, in cases where a safe fall is made on the rope, the roller tends to slide back to the starting point due to the effect of gravity with the present invention.

This situation has been prevented and the development of existing products and the closing of security gaps have been ensured with the help of said invention. At the same time, the instant location of the roller users and their density regions can be followed by means of the RFID chip thereon.

### REFERENCE LIST

1—Central security point
2—Side surfaces
3—Moving roller
4—Plastic external coating
5—Backward anti-slip valve
6—Spring
7—Swivel
8—Valve bearing housing
9—Valve bearing
10—Valve limiter fixed wedge
20—Brake system wedge
30—Security connection apparatus
100—Rope
200—Backward anti-slip wedge

### DESCRIPTION OF FIGURES

FIG. 1—Exploded perspective view of the roller

FIG. 2—Exploded plan view of the roller

FIG. 3—Exploded right side perspective view of the roller

FIG. 4—Exploded left bottom perspective view of the roller

FIG. 5—Right side internal view of the roller

FIG. 6—Left rear view with roller mounted

FIG. 7—First position view of the roller passing over the anti-slip wedge

FIG. 8—View of the passage of the roller over the anti-slip wedge, second position swivel opening view.

FIG. 9—View of the passage of the roller over the backward anti-slip wedge, the first contact view of the third position swivel with the backward anti-slip wedge during back-sliding.

FIG. 10—View of the passage of the roller over the backward anti-slip wedge, the full contact view of the fourth position swivel with the backward anti-slip wedge during back-sliding.

FIG. 11—View of the passage of the roller over the backward anti-slip wedge, the fifth position swivel to stop with backward anti-slip wedge during back-sliding.

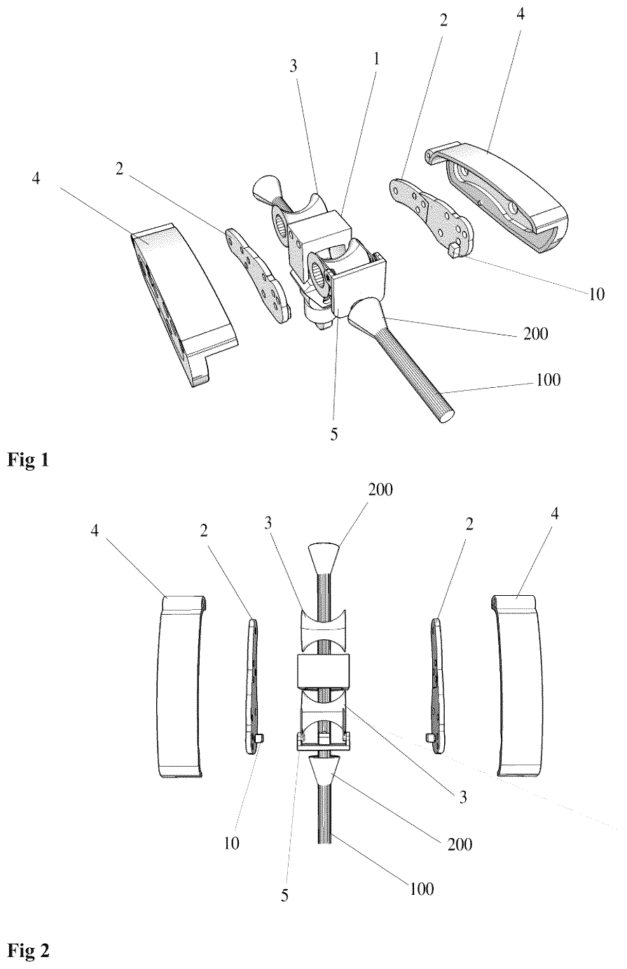

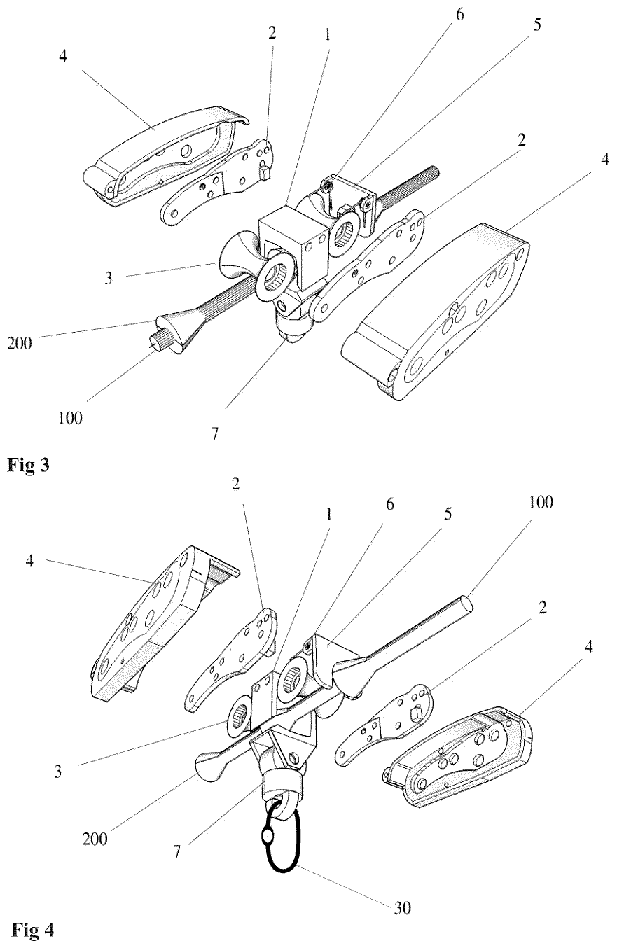

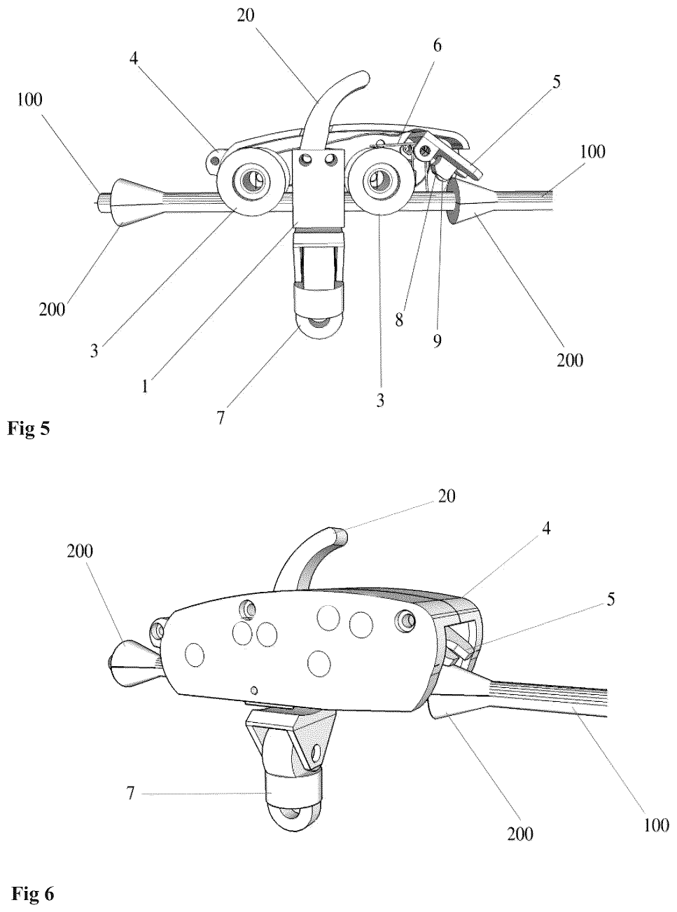

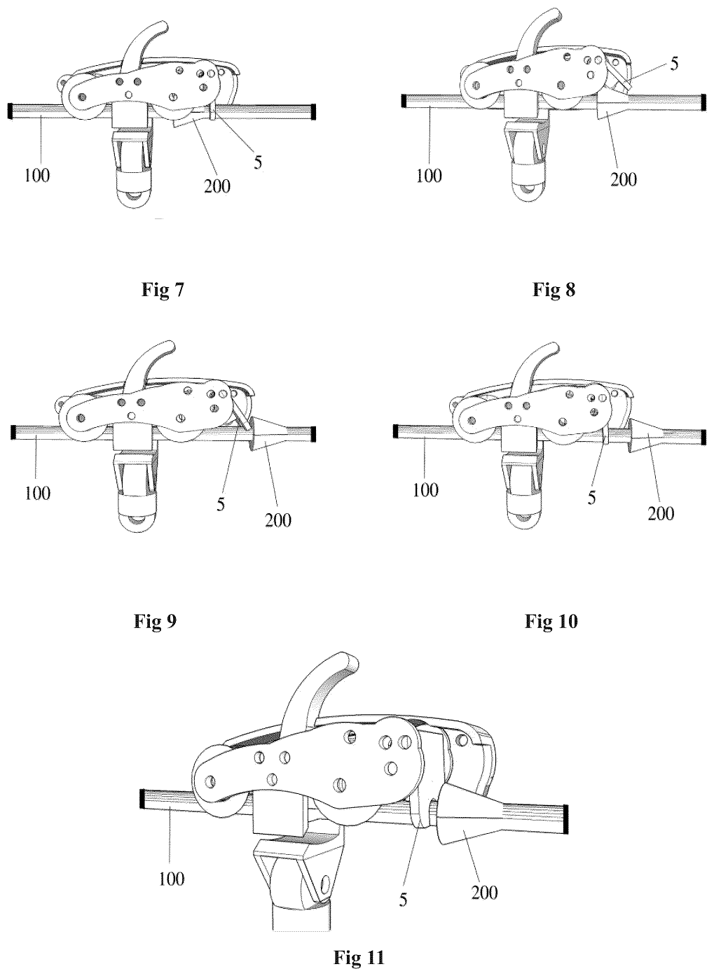

The parts that constitute the present invention and the geometric shapes of these parts are drawn as a representation and do not create any limiting effect.

### DETAILED DESCRIPTION OF THE INVENTION

The central safety point (1), where the side surfaces (2) and the swivel (7) parts are attached,
Side surfaces (2) that are located in the center, placed on the central security point (1), consisting of 2 symmetrical parts, on which movable roller (3), plastic outer cover (4) anti-slip valve (5) spring (6) are attached to the spaces thereon, moving roller (3) that is movable and wear-resistant placed between the side surfaces (2) part, allows the wedge (200) part to pass without being stuck with the help of its oval design,
plastic external coating (4) that is placed on the side surfaces (2) part, enables intervention of the moving parts in the interior from the outside, is designed to prevent the parts to be jammed from getting inside, to be protected from rain or sun rays, and also to prevent the user from being harmed (such as pinching his/her hand, rubbing against the rope, etc.),
backward anti-slip valve (5) that is placed on the side surfaces (2) part, opens only in one direction and then closes by itself with the help of the spring (6) engaged thereto, allows itself to pass through the wedge (200), then, comes to a position to prevent the roller from slipping back by closing with the help of the spring (6),
spring (6) that is connected between the anti-slip valve (5) and the side surfaces (2), ensures that the anti-slip valve (5) is closed after the wedge passage,
swivel (7) which is the part used for the connection of the user of the safety roller and the part on which the parts (e.g., carabiner, caver carabiner, locked carabiner, etc.) that will ensure a safe connection with the user are attached,
valve bearing housing (8), that is integrated on the backward anti-slip valve (5), in which the valve bearing (9) is inserted,
valve bearing (9) that is placed inside the valve bearing housing (8) part, is used to reduce friction during the passage of the wedge (200) part on the steel rope (100) and to enable the same to move freely on the steel rope,
valve limiter fixed wedge (10), which is the fixed part on the side surfaces (2) part, brake system wedge (20), which is placed on the central safety point (1) and can be removed when not desired,
security connection apparatus (30),
rope (100), which is the part that ensures the safety of the users,
security backward anti-slip wedge (200), which is placed on the steel rope (100) and works in interaction with the anti-slip valve (5) cover in sloping areas,

The parts in the figures are enumerated and their equivalents are as follows:

The central safety point (1) is the part, where the side surfaces (2) and the swivel (7) parts are attached. The wedge (200) can easily pass through it with the help of the space therein. The brake system wedge (20) can be mounted by means of the slots located on the upper part of the central safety point. It can be mounted on the side surfaces (2) parts by means of the slots on the central security point (1). The swivel (7) part located on the lower side of the central security point (1) can be mounted. The central safety part is made of materials that are resistant to abrasion, impacts and the loads that may occur thereon.

The side surfaces (2) are the parts mounted on the central safety point (1). The side surfaces (2) contain slots so that the parts inside can be mounted and fixed. The parts placed inside the side surfaces part are as follows; moving roller (3), plastic external cover (4) anti-slip valve (5), spring (6). There is a valve limiter fixed wedge (10) protrusion, which is stationary on the side surfaces (2) and protrudes outward. The complete roller is prevented from sliding back in the sloping areas with the help of the anti-slip valve (5) and the spring (6) placed on the side surfaces (2). In this way, possible accidents of users are prevented. There is a valve limiter fixed wedge (10) on the side surfaces (2).

The moving roller (3) is the part fixed between the side surfaces (2) parts. The moving roller can rotate around its own axis by means of the bearings therein. The moving roller (3) provides ease in the transition of the wedge (200) with the help of its design and wide inner oval structure. The moving roller (3) allows the wedge (200) to move freely without getting stuck while passing through the roller as a whole, and allows the movement capability that passes over it with its oval structure. The movable roller (3) is a friction-resistant and durable part.

The plastic external part (4) is the part that comes to the top of all the moving and stationary parts therein. It does not allow the connection parts on the central security point and the side surfaces to be interfered with from the outside. At the same time, it prevents the user's hand or other objects from pinching the entire pulley during the movements of the moving parts therein such as the moving roller (3), the backward anti-slip valve (5). The plastic external cover (4) allows users to avoid accidents that occur in the event of collision or friction with the entire roller with minimum damage with the help of its oval structure. The gap on the upper part of the plastic external cover (4) allows the brake system wedge (20) to be attached and removed whenever desired.

The anti-slip valve (5) is mounted inside the side surfaces (2) parts. Backward anti-slip valve (5) is a movable part. It allows the wedge (200) part on the steel rope (100) to pass depending on the direction of passage during their passage. The backward anti-slip valve (5) desires to return to its original position after the wedge (200) passes by means of the spring (6) engaged thereto. The backward anti-slip valve (5) is a cover that allows passage in one direction. The backward anti-slip valve (5) allows passage or prevents back-slip depending on the conical structure of the wedge. The backward anti-slip valve allows the entire roller to move in one direction with this property. The backward anti-slip valve (5) is located at the rear of the roller assembly in the direction of progress. In this way, if the roller assembly is placed on the steel rope (100) in the wrong direction (for cases where the backward anti-slip valve (5) is located at the front), it gets stuck on the wedge and restricts its progress, this situation restricts the misuse of the roller and prevents possible accidents. The valve limiter wedge (10) located on the side surfaces (2) is the part of the backward anti-slip valve that restricts its opening in one direction and its movements in the other direction.

The spring (6) is the part mounted between the backward anti-slip valve (5) and the side surfaces (2). It is the part of the backward anti-slip valve (5) that creates a force for the same to return to its original position after it moves. In cases where the spring (6) fails, the anti-slip valve (5) cannot fulfill its duty.

The swivel (7) is the moving part mounted under the center safety point (1). Security connection apparatus (30) can be connected to the slots on the swivel (7). In this way, the user can be connected to the safety roller as a whole. The swivel (7) can move around its own axis and connection axis with the help of its movable parts. The security roller reduces the loads on the roller in the movements of the whole in different directions with its mobility. It prevents the connection apparatus made by the user from buckling with its rotation ability.

The valve roller bearing (8) is the fixed part on the backward anti-slip valve (5). The valve bearing (9) is placed inside the valve bearing housing (8). The task of the valve bearing housing (8) and valve bearing (9) is to provide preliminary contact during the passage of the wedge (200) on the steel rope (100) and to allow the wedge to pass by opening the backward anti-slip valve (5).

The valve bearing (8) is the moving part that is mounted inside the valve bearing housing (9). Valve bearing (9) provides ease of opening in wedge (200) transitions with the help of its movable structure. The valve bearing (9) also prevents the steel rope (100) from rubbing against the backward anti-slip valve (5) cover, thus ensuring that the backward anti-slip valve (5) cover is not worn and damaged. The wedge (200) makes contact with the valve bearing (9) during its passage through the roller assembly and ensures that the cover is opened healthily with the help of its conical structure and thus prevents it from getting stuck in the oval groove structure in the backward anti-slip valve (5).

There is a valve limiter fixed wedge (10) is a protrusion placed on the side surfaces (2). This rear section, which is located on the side surfaces (2) parts, is designed to limit the reverse movements of the wedge (200) to this cover after the cover of the backward anti-slip valve (5) is opened. The valve limiter wedge (10) is one of the most important parts that supports the one-way operation of the backward anti-slip valve (5)

Brake system wedge (20), is a portable part that is mounted on the top of the central safety point (1) and can be removed when not desired. Brake system wedge (20) is a one-way protrusion designed to prevent repulsion in activities to be carried out on the safety line and in braking systems for stopping purposes.

The safety connection apparatus (30) is a detachable connection piece that users use when connecting to the roller assembly.

The steel rope (100) is the safety rope on which the roller assembly travels.

The wedge (200) is a conical piece placed on the steel rope (100) in order to prevent the roller from sliding back on sloping areas. The wedge (200) allows the movement of the roller in one-way transitions with the help of its conical structure.

The assembly of the present invention is performed as follows during the manufacturing phase.

Brake system wedge (20) and swivel (7) parts are mounted on the central safety point (1).

The spring (6), the valve bearing housing (8) and the valve bearing (9) are mounted on the backward anti-slip valve (5).

Moving roller (3) part, center safety point (1) part, backward anti-slip valve (5) part, assembled with spring (6) on (between) the side surfaces (2).

The assembly of the product is completed by mounting the number 4 plastic external coating (4) parts on the side surfaces (2).

The operating principle of the inventive system is as follows and is explained in detail:

While the wedge (200) on the steel rope (100) and the roller assembly moving on it pass over the wedge (200), located in the rear section, the backward anti-slip valve (5) allows the passage of the wedge (200) passing through it during the forward movements of the roller and closes immediately after the wedge (200) passes by means of the spring (6) thereon. The backward anti-slip valve (5) cover can climb over this form and the cover can make an opening movement in one direction with the help of the special conical form of the wedge (200) and the cover can make an opening movement in one direction. This one-way backward anti-slip valve action ensures a safer ride to the roller.

The valve (5) located at the back of the roller allows the wedge (200) passing through it to move in one direction, after passing through it, it closes with the help of the tension spring (6) to which it is attached and prevents the wedge (200) from passing through the roller again. This situation allows the roller on the steel rope (100) to move in one direction and at the same time restricts/prevents its movement in the opposite direction. This is achieved by placing wedges (200) on the steel rope (100) in one direction. This system, which allows the roller assembly to move in one direction, integrated with the wedge and backward anti-slip valve cover, prevents users gaining altitude on the wire rope (gaining altitude; upward movement) from slipping back on the steel rope (100) and colliding with the other user. At the same time, it allows users to create traffic in one direction and act in harmony in adventure park areas.

1. Backward anti-slip adventure park roller, wherein, it comprises of the following;
central safety point, where the side surfaces and the swivel parts are attached, side surfaces that are located in the center, placed on the central security point, consisting of 2 symmetrical parts, on which movable roller, plastic outer cover anti-slip valve spring are attached to the spaces thereon,
moving roller that is movable and wear-resistant placed between the side surfaces part, allows the wedge part to pass without being stuck with the help of its oval design,
plastic external coating that is placed on the side surfaces part, enables intervention of the moving parts in the interior from the outside, is designed to prevent the parts to be jammed from getting inside, to be protected from rain or sun rays, and also to prevent the user from being harmed (such as pinching his/her hand, rubbing against the rope, etc.),
backward anti-slip valve that is placed on the side surfaces part, opens only in one direction and then closes by itself with the help of the spring engaged thereto, allows itself to pass through the wedge, then, comes to a position to prevent the roller from slipping back by closing with the help of the spring,
spring that is connected between the anti-slip valve and the side surfaces, ensures that the anti-slip valve is closed after the wedge passage,
swivel which is the part used for the connection of the user of the safety roller and the part on which the parts (e.g., carabiner, caver carabiner, locked carabiner, etc.) that will ensure a safe connection with the user are attached,
valve bearing housing, that is integrated on the backward anti-slip valve, in which the valve bearing is inserted,
valve bearing that is placed inside the valve bearing housing part, is used to reduce friction during the passage of the wedge part on the steel rope and to enable the same to move freely on the steel rope,
valve limiter fixed wedge, which is the fixed part on the side surfaces part,
brake system wedge, which is placed on the central safety point and can be removed when not desired,
security connection apparatus,
rope, which is the part that ensures the safety of the users,
security backward anti-slip wedge, which is placed on the steel rope and works in interaction with the anti-slip valve cover in sloping areas.

2. The backward anti-slip adventure park roller according to claim 1, wherein; it comprises a central safety point to which side surfaces and swivel parts are attached, through which the wedge can easily pass with the help of the space therein, to which the brake system wedge can be installed with the help of the slots on the upper side, and which can be mounted on the side surfaces parts by means of the slots thereon, to which the swivel part on the bottom can be mounted, consists of materials resistant to abrasion, impacts and loads that may occur thereon.

3. The backward anti-slip adventure park roller according to claim 1, wherein; it comprises side surfaces which are mounted on the central security point, have slots for mounting and fixing the parts inside, and have the parts placed inside as follows; moving roller, plastic external cover, backward anti-slip valve, spring, which has calve limiter fixed wedge protrusion that stands fixedly on the side surfaces part, protruding outward, prevents the roller assembly from slipping back on inclined areas by means of the backward anti-slip valve and the spring placed thereon, thus have valve limiter fixed wedge thereon so as to prevent possible accidents of the user.

4. The backward anti-slip adventure park roller according to claim 1, wherein; it comprises moving roller whose side surfaces are fixed between its parts, which can rotate around its own axis by means of the bearings inside, provides convenience in the transition of wedges with the help of its design and wide inner oval structure, allows the wedge to move freely without getting stuck while passing through the roller assembly and to allow the movement capability that passes over the same, is friction resistant and durable.

5. The backward anti-slip adventure park roller according to claim 1, wherein, it comprises plastic external coating which is at the top of all moving and stationary parts therein, prevents the connection parts on the central security point and the side surfaces from being interfered with from the outside, at the same time, prevents the user from squeezing his/her hand or other objects into the roller assembly during the movements of moving parts such as the moving roller, the backward anti-slip valve and the like, allows users to avoid accidents that occur in case of collision or friction with the roller assembly with minimum damage with the help of its oval structure, allows the brake system wedge to be mounted and removed whenever desired with the space on the upper part of it.

6. The backward anti-slip adventure park roller according to claim 1, wherein, it comprises backward anti-slip valve which is mounted inside the side surfaces, is a moving part, allows the wedge piece on the steel rope to pass depending on the direction of passage during their passage, returns to its former position after the wedge passes, with the help of the spring engaged with it, allows passage in one direction, allows passage or prevents back-slipping according to the conical structure of the wedge, allows the roller assembly to move in one direction, is located behind the direction of travel of the roller assembly and thus sticks on the wedge and restricts its progress if the roller assembly is placed on the steel rope in the wrong direction (for cases where the backward anti-slip valve is located at the front), this situation restricts the misuse of the roller and prevents possible accidents), allows the valve limiter wedge, backward anti-slip valve on side surfaces to open in one direction and restricts their movement in the other direction.

7. The backward anti-slip adventure park roller according to claim 1, wherein, it comprises spring which is mounted between the backward anti-slip valve and the side surfaces, creates a force for the backward anti-slip valve to return to its original position after it moves.

8. The backward anti-slip adventure park roller according to claim 1, wherein, it comprises swivel which is the movable part mounted under the central security point and on which a security connection apparatus can be connected to the slots thereon and thus which enables the user connection with the roller assembly, can move around its own axis and connection axis with the help of its moving parts, reduces the loads on the roller in the movements of the safety roller assembly in different directions with its mobility, prevents buckling of the connection apparatus made by the user with its rotation ability.

9. The backward anti-slip adventure park roller according to claim 1, wherein, it comprises valve bearing housing which is the fixed part on the backward anti-slip valve, in which valve bearing can be placed and which allows the valve bearing to provide preliminary contact during the passage of the wedge on the steel rope and to open the anti-slip valve, allows the wedge to pass.

10. The backward anti-slip adventure park roller according to claim 1, wherein, it comprises valve bearing which is mounted in the valve bearing housing, provides ease of opening with the help of its movable structure in wedge transitions, at the same time prevents the steel rope from rubbing against the backward anti-slip valve cover, prevents wear and damage to the backward anti-slip valve cover, provides a healthy opening of the cover by making contact beforehand during the pass through the roller assembly with the help of the conical structure of the wedge and thus prevents the backward anti-slip valve from getting stuck in the oval corrugated structure therein.

11. The backward anti-slip adventure park roller according to claim 1, wherein, it comprises valve limiter wedge which has a protrusion located on the side surfaces, is a rear section located on the side surface parts, limits the reverse movements of the wedge to this cover after the cover of the backward anti-slip valve is opened, supports the one-way operation of the backward anti-slip valve.

12. The backward anti-slip adventure park roller according to claim 1, wherein, it comprises brake system wedge which is mounted on the upper section of the central security point and is a portable piece that can be disassembled when not desired, is used to prevent repulsion in activities to be carried out on the safety line and in braking systems for stopping purposes, is a one-way protrusion.

13. The backward anti-slip adventure park roller according to claim 1, wherein, it comprises a security connection apparatus, which is a detachable connection piece that users use when connecting to the roller assembly.

14. The backward anti-slip adventure park roller according to claim 1, wherein, it comprises conical shaped wedge which is placed on the steel rope so as to prevent the roller assembly from slipping back on sloping areas, allows the movement of the roller in one-way transitions with the help of its conical structure.
